(19) United States
(12) Patent Application Publication
(10) Pub. No.: US 2024/0406688 A1
(43) Pub. Date: Dec. 5, 2024

(54) GATEWAY SYSTEM

(71) Applicant: BRYMEN TECHNOLOGY CORPORATION, New Taipei City (TW)

(72) Inventor: Po-Chao TAN, New Taipei City (TW)

(21) Appl. No.: 18/243,641

(22) Filed: Sep. 7, 2023

(30) Foreign Application Priority Data
May 29, 2023 (TW) 112205382

(51) Int. Cl. H04W 4/38

(52) U.S. Cl. CPC H04W 4/38; H04W 88/16

(57) ABSTRACT

An improved-type gateway system (10) includes an improved-type gateway (102) and a plurality of measurers (106). The measurers (106) are wirelessly connected to the improved-type gateway (102). The improved-type gateway (102) includes a gateway (142) and a display (104). The gateway (142) is wirelessly connected to the measurers (106). The display (104) is electrically connected to the gateway (142).

### BACKGROUND OF THE DISCLOSURE

### Technical Field

The present disclosure relates to a gateway system, and especially relates to an improved-type gateway system.

### Description of Related Art

A related art measurer converts a data which is measured into a first communication protocol signal (for example, a Bluetooth signal) through a first communication protocol to wirelessly transmit the first communication protocol signal to a related art gateway. Then, the related art gateway converts the first communication protocol signal into a second communication protocol signal (for example, a Wi-Fi signal) and transmits the second communication protocol signal to a related art server. Finally, the related art server decodes the second communication protocol signal to display the data measured by the related art measurer. Therefore, the related art gateway is very important and is used widely.

However, the disadvantage of the related art gateway is that the related art gateway cannot display the data measured by the related art measurer, so that the user must use the related art server or a related art mobile apparatus to see the data measured by the related art measurer, which is very inconvenient.

### SUMMARY OF THE DISCLOSURE

In order to solve the above-mentioned problems, an object of the present disclosure is to provide an improved-type gateway system.

In order to achieve the object of the present disclosure mentioned above, the improved-type gateway system of the present disclosure includes an improved-type gateway and a plurality of measurers. The measurers are wirelessly connected to the improved-type gateway. Moreover, the improved-type gateway includes a gateway and a display. The gateway is wirelessly connected to the measurers. The display is electrically connected to the gateway.

Moreover, in an embodiment of the improved-type gateway system of the present disclosure mentioned above, the improved-type gateway further includes a measurement parameter setting circuit electrically connected to the gateway. Moreover, the measurement parameter setting circuit is at least one button, or the measurement parameter setting circuit and the display are integrated as a touch screen.

Moreover, in an embodiment of the improved-type gateway system of the present disclosure mentioned above, the gateway includes a microprocessor and a first wireless transceiver. The microprocessor is electrically connected to the display and the measurement parameter setting circuit. The first wireless transceiver is electrically connected to the microprocessor. The first wireless transceiver is wirelessly connected to the measurers. Moreover, the microprocessor includes a first signal processor and a second signal processor. The first signal processor is electrically connected to the first wireless transceiver. The second signal processor is electrically connected to the first signal processor.

Moreover, in an embodiment of the improved-type gateway system of the present disclosure mentioned above, the microprocessor further includes a first decoder and a first complier. The first decoder is electrically connected to the first signal processor. The first complier is electrically connected to the first signal processor and the first decoder.

Moreover, in an embodiment of the improved-type gateway system of the present disclosure mentioned above, the microprocessor further includes a second decoder and a second complier. The second decoder is electrically connected to the second signal processor. The second complier is electrically connected to the second signal processor and the second decoder.

Moreover, in an embodiment of the improved-type gateway system of the present disclosure mentioned above, the gateway further includes a second wireless transceiver electrically connected to the second signal processor.

Moreover, in an embodiment of the improved-type gateway system of the present disclosure mentioned above, the improved-type gateway system further includes a backend apparatus wirelessly connected to the second wireless transceiver. Moreover, the backend apparatus includes a wireless transceiver wirelessly connected to the second wireless transceiver.

Moreover, in an embodiment of the improved-type gateway system of the present disclosure mentioned above, each of the measurers includes a measurement side wireless transceiver and a sensor. The measurement side wireless transceiver is wirelessly connected to the first wireless transceiver. The sensor is electrically connected to the measurement side wireless transceiver.

Moreover, in an embodiment of the improved-type gateway system of the present disclosure mentioned above, the gateway further includes a power supply circuit electrically connected to the display, the measurement parameter setting circuit, the microprocessor, the first wireless transceiver and the second wireless transceiver. Moreover, the power supply circuit is a battery or an external power switching circuit.

Moreover, in an embodiment of the improved-type gateway system of the present disclosure mentioned above, the gateway further includes a first Ethernet circuit electrically connected to the second signal processor, the power supply circuit, and the backend apparatus. Moreover, the backend apparatus is a server, a personal computer, or a mobile apparatus. The backend apparatus further includes a second Ethernet circuit electrically connected to the first Ethernet circuit.

The advantage of the present disclosure is to enable the gateway to display the data measured by the measurers.

Please refer to the detailed descriptions and figures of the present disclosure mentioned below for further understanding the technology, method and effect of the present disclosure achieving the predetermined purposes. It believes that the purposes, characteristic and features of the present disclosure can be understood deeply and specifically. However, the figures are only for references and descriptions, but the present disclosure is not limited by the figures.

### BRIEF DESCRIPTION OF THE DRAWINGS

FIG. 1 shows a block diagram of the first embodiment of the improved-type gateway system of the present disclosure.

FIG. 2 shows a block diagram of the second embodiment of the improved-type gateway system of the present disclosure.

FIG. 3 shows an appearance diagram of an embodiment of the improved-type gateway of the present disclosure.

### DETAILED DESCRIPTION

In the present disclosure, numerous specific details are provided, to provide a thorough understanding of embodiments of the disclosure. Persons of ordinary skill in the art will recognize, however, that the present disclosure can be practiced without one or more of the specific details. In other instances, well-known details are not shown or described to avoid obscuring aspects of the present disclosure. Now please refer to the figures for the explanation of the technical content and the detailed description of the present disclosure:

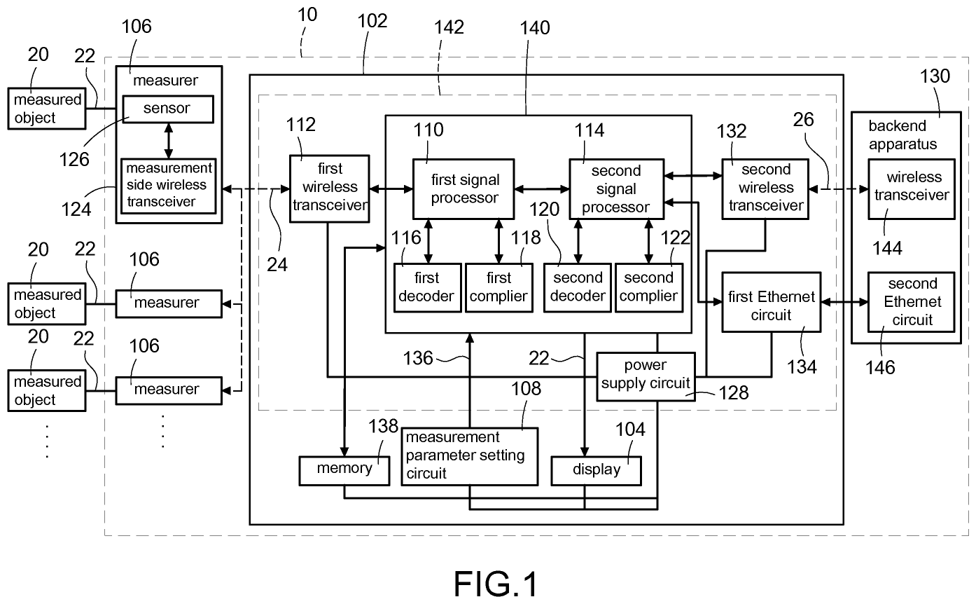

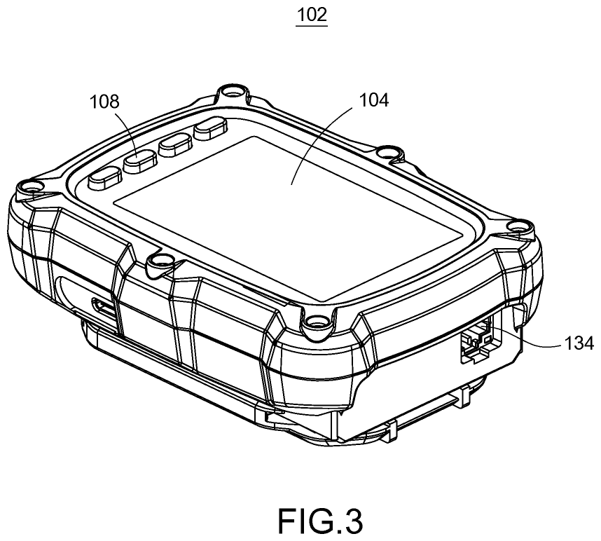

FIG. 1 shows a block diagram of the first embodiment of the improved-type gateway system 10 of the present disclosure. FIG. 3 shows an appearance diagram of an embodiment of the improved-type gateway 102 of the present disclosure. The improved-type gateway system 10 includes an improved-type gateway 102, a plurality of measurers 106 and a backend apparatus 130. The improved-type gateway 102 includes a display 104, a measurement parameter setting circuit 108, a memory 138 and a gateway 142. Each of the measurers 106 includes a measurement side wireless transceiver 124 and a sensor 126. The backend apparatus 130 includes a wireless transceiver 144 and a second Ethernet circuit 146. The gateway 142 includes a first wireless transceiver 112, a power supply circuit 128, a second wireless transceiver 132, a first Ethernet circuit 134 and a microprocessor 140. The microprocessor 140 includes a first signal processor 110, a second signal processor 114, a first decoder 116, a first complier 118, a second decoder 120 and a second complier 122. The aforementioned components are electrically or wirelessly connected to each other. The measurement parameter setting circuit 108 is at least one button, or the measurement parameter setting circuit 108 and the display 104 are integrated as a touch screen. The power supply circuit 128 is a battery or an external power switching circuit. The backend apparatus 130 is a server, a personal computer, or a mobile apparatus. The architecture shown in FIG. 1 may be called the IoT architecture.

Moreover, the improved-type gateway system 10 is applied to a plurality of measured objects 20. The measurers 106 are configured to measure the measured objects 20 to obtain a plurality of data 22 (for example, temperature values, voltage values or current values) of the measured objects 20 and convert the data 22 into a plurality of first communication protocol signals 24 (for example, Bluetooth signals) through a first communication protocol (for example, Bluetooth communication protocol) and wirelessly transmit the first communication protocol signals 24 to the improved-type gateway 102. The improved-type gateway 102 is configured to decode the first communication protocol signals 24 to obtain the data 22 and transmit the data 22 to the display 104 to display the data 22. The improved-type gateway 102 is configured to convert the data 22 into a plurality of second communication protocol signals 26 (for example, Wi-Fi signals) through a second communication protocol (for example, Wi-Fi communication protocol). The measurers 106 are wireless temperature sensors, wireless voltage sensors, wireless current sensors, or wireless electric meters with wireless signal transmission functions. The first communication protocol and the second communication protocol may be, for example but not limited to, Bluetooth communication protocol, Wi-Fi communication protocol, long-range (LoRa) communication protocol, ZigBee communication protocol or long-term evolution (LTE) technology communication protocol.

Moreover, the measurement parameter setting circuit 108 is configured to transmit a measurement parameter setting signal 136 to the microprocessor 140. The first signal processor 110 is configured to utilize the first complier 118 to encode the measurement parameter setting signal 136 to wirelessly transmit to the measurers 106 through the first wireless transceiver 112, so that the gateway 142 is configured to wirelessly control the measurers 106 to measure the measured objects 20 based on the measurement parameter setting signal 136. For example, the measurement parameter setting signal 136 is a high-voltage-and-low-voltage warning signal. When the measurers 106 measure a plurality of voltages of the measured objects 20 and find that the voltages of the measured objects 20 are higher than a high voltage threshold or lower than a low voltage threshold in the high-voltage-and-low-voltage warning signal, the measurers 106 send out an alarm. Or for example, the measurement parameter setting signal 136 is a high-temperature-and-low-temperature warning signal. When the measurers 106 measure a plurality of temperatures of the measured objects 20 and find that the temperatures of the measured objects 20 are higher than a high temperature threshold or lower than a low temperature threshold in the high-temperature-and-low-temperature warning signal, the measurers 106 send out an alarm. For another example, the measurement parameter setting signal 136 is a transmission rate setting signal, so as to set a transmission rate at which the measurers 106 wirelessly transmit the first communication protocol signals 24 to the improved-type gateway 102.

Moreover, the first wireless transceiver 112, the microprocessor 140, the first signal processor 110 and the first decoder 116 are configured to receive the first communication protocol signals 24 and decode the first communication protocol signals 24 to obtain the data 22, and then the microprocessor 140 is configured to transmit the data 22 to the display 104 to display the data 22. The first signal processor 110 and the first decoder 116 are configured to transmit the data 22 to the second signal processor 114 and the second compiler 122. The microprocessor 140, the second signal processor 114, the second compiler 122 and the second wireless transceiver 132 are configured to convert the data 22 into the second communication protocol signals 26 through the second communication protocol, and wirelessly transmit the second protocol communication signals 26 to the backend apparatus 130. The microprocessor 140, the first signal processor 110, the first compiler 118 and the first wireless transceiver 112 are configured to receive the measurement parameter setting signal 136 and wirelessly control the measurers 106 to measure the measured objects 20 based on the measurement parameter setting signal 136.

Moreover, the improved-type gateway 102 further includes a memory 138 electrically connected to the microprocessor 140. The memory 138 is configured to store the data 22 as a history record, and the display 104 is configured to display a history record graph corresponding to the history record.

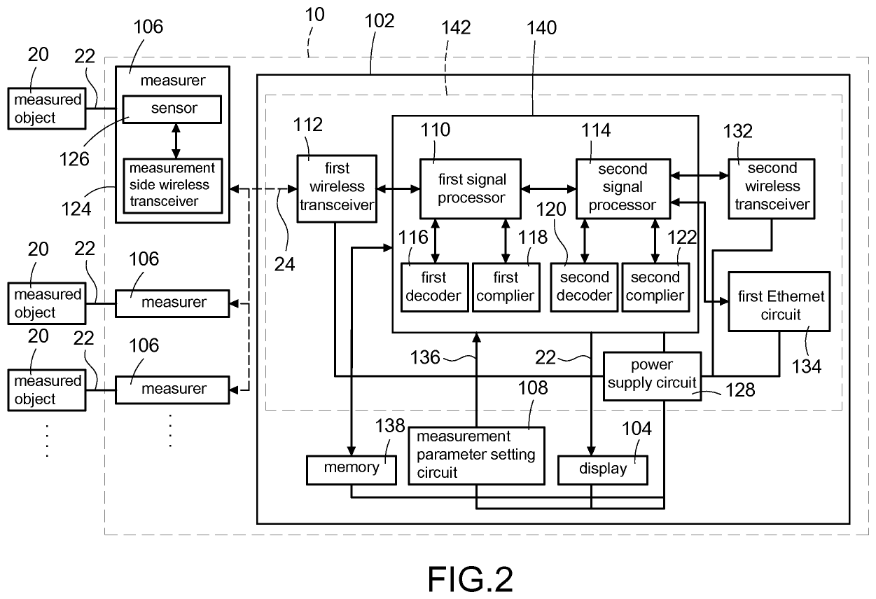

FIG. 2 shows a block diagram of the second embodiment of the improved-type gateway system 10 of the present disclosure. The descriptions of the elements shown in FIG. 2 which are the same as the elements shown in FIG. 1 are not repeated here for brevity. Compared with FIG. 1, FIG. 2 omits the backend apparatus 130. The improved-type gateway 102 of FIG. 2 may include the recording, the control setting and the display functions of the backend apparatus 130 shown in FIG. 1, so that the backend apparatus 130 of FIG. 2 is omitted.

The advantage of the present disclosure is to enable the gateway to display the data measured by the measurers without using the backend apparatus 130 to display, which is very convenient. The present disclosure may also set the measurement parameters of the sensors without using the backend apparatus 130 to control the sensors, which is very convenient. The present disclosure may independently become the sensor's long-distance monitoring host or long-distance control host to be applied to the long-distance monitoring in high-voltage dangerous areas. The present disclosure may install a battery and then may become hand-held.

Although the present disclosure has been described with reference to the embodiment thereof, it will be understood that the disclosure is not limited to the details thereof. Various substitutions and modifications have been suggested in the foregoing description, and others will occur to those of ordinary skill in the art. Therefore, all such substitutions and modifications are intended to be embraced within the scope of the disclosure as defined in the appended claims.

What is claimed is:

1. An improved-type gateway system (10) comprising:
an improved-type gateway (102); and
a plurality of measurers (106) wirelessly connected to the improved-type gateway (102),
wherein the improved-type gateway (102) comprises:
a gateway (142) wirelessly connected to the measurers (106); and
a display (104) electrically connected to the gateway (142).

2. The improved-type gateway system (10) of claim 1, wherein the improved-type gateway (102) further comprises:
a measurement parameter setting circuit (108) electrically connected to the gateway (142),
wherein the measurement parameter setting circuit (108) is at least one button, or the measurement parameter setting circuit (108) and the display (104) are integrated as a touch screen.

3. The improved-type gateway system (10) of claim 2, wherein the gateway (142) comprises:
a microprocessor (140) electrically connected to the display (104) and the measurement parameter setting circuit (108); and
a first wireless transceiver (112) electrically connected to the microprocessor (140), and wirelessly connected to the measurers (106),
wherein the microprocessor (140) comprises:
a first signal processor (110) electrically connected to the first wireless transceiver (112); and
a second signal processor (114) electrically connected to the first signal processor (110).

4. The improved-type gateway system (10) of claim 3, wherein the microprocessor (140) further comprises:
a first decoder (116) electrically connected to the first signal processor (110); and
a first complier (118) electrically connected to the first signal processor (110) and the first decoder (116).

5. The improved-type gateway system (10) of claim 4, wherein the microprocessor (140) further comprises:
a second decoder (120) electrically connected to the second signal processor (114); and
a second complier (122) electrically connected to the second signal processor (114) and the second decoder (120).

6. The improved-type gateway system (10) of claim 5, wherein the gateway (142) further comprises:
a second wireless transceiver (132) electrically connected to the second signal processor (114).

7. The improved-type gateway system (10) of claim 6, further comprising:
a backend apparatus (130) wirelessly connected to the second wireless transceiver (132),
wherein the backend apparatus (130) comprises:
a wireless transceiver (144) wirelessly connected to the second wireless transceiver (132).

8. The improved-type gateway system (10) of claim 7, wherein each of the measurers (106) comprises:
a measurement side wireless transceiver (124) wirelessly connected to the first wireless transceiver (112); and
a sensor (126) electrically connected to the measurement side wireless transceiver (124).

9. The improved-type gateway system (10) of claim 8, wherein the gateway (142) further comprises:
a power supply circuit (128) electrically connected to the display (104), the measurement parameter setting circuit (108), the microprocessor (140), the first wireless transceiver (112) and the second wireless transceiver (132),
wherein the power supply circuit (128) is a battery or an external power switching circuit.

10. The improved-type gateway system (10) of claim 9, wherein the gateway (142) further comprises:
a first ethernet circuit (134) electrically connected to the second signal processor (114), the power supply circuit (128) and the backend apparatus (130),
wherein the backend apparatus (130) is a server, a personal computer, or a mobile apparatus; the backend apparatus (130) further comprises:
a second ethernet circuit (146) electrically connected to the first ethernet circuit (134).
